(19) United States
(12) Patent Application Publication
(10) Pub. No.: US 2010/0039738 A1
(43) Pub. Date: Feb. 18, 2010

(54) Inductive coupler for power line communications, having a member that provides an intended path for a flashover to discharge to ground

(76) Inventor: Erik Steck Merck, Sharon, MA (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/918,619

(22) PCT Filed: May 19, 2006
(86) PCT No.: PCT/US2006/019453

§ 371 Date: Oct. 16, 2007

Related U.S. Application Data
(60) Provisional application No. 60/682,932, filed on May 20, 2005.

(51) Int. Cl. H02H 7/04

(52) U.S. Cl. 361/40

(57) ABSTRACT

There is provided an inductive coupler for coupling a signal to a power line. The inductive coupler includes (a) a magnetic core having an aperture through which the power line is routed, (b) a winding wound around a portion of the magnetic core, where the signal is coupled between the winding and the power line via the magnetic core, and (c) an electrically conductive member on an exterior of the inductive coupler that provides a path to electrical ground for a flashover current.

### BACKGROUND OF THE INVENTION

1. Field of the Invention

The present invention relates to power line communications, and more particularly, to a configuration of a data coupler for power line communications.

2. Description of the Related Art

Power line communications (PLC), also known as broadband over power line (BPL), is a technology that encompasses transmission of data at high frequencies through existing electric power lines, i.e., conductors used for carrying a power current. A data coupler for power line communications couples a data signal between a power line and a communication device such as a modem.

An example of such a data coupler is an inductive coupler that includes a set of cores, and a winding wound around a portion of the cores. The inductive coupler operates as a transformer, where the cores are situated on a power line such that the power line serves as a primary winding of the transformer, and the winding of the inductive coupler is a secondary winding of the transformer.

The cores are typically constructed with magnetic materials, such as ferrites, powdered metal, or nano-crystalline material. The cores are electrified by contact with the power line and require insulation from the secondary winding. Typically, insulation is provided between the cores and secondary winding by embedding both the cores and the secondary winding in electrically insulating material, such as epoxy.

An inductive coupler is required to meet safety requirements to avoid injury to personnel performing installation, maintenance and removal of communications equipment. At times a phenomenon may occur where the voltage exceeds the utility line voltage class rating. At this elevated voltage, air, water or any other foreign gas, liquid or solid particle found in an outdoor environment can act as a conductive path allowing for a disruptive discharge over the surface of a solid insulation. The industry terms this occurrence, flashover (reference: IEEE 4-1995 Standard, Techniques for High Voltage Testing). A flashover to an insulated conductor of an inductive coupler may puncture the insulation of the conductor, and/or damage the conductor itself. The puncture or damage is considered a failure of the inductive coupler, and should be avoided.

### SUMMARY OF THE INVENTION

There is provided an inductive coupler for coupling a signal to a power line. The inductive coupler includes (a) a magnetic core having an aperture through which the power line is routed, (b) a winding wound around a portion of the magnetic core, wherein the signal is coupled between the winding and the power line via the magnetic core, and (c) an electrically conductive member on an exterior of the inductive coupler that provides a path to electrical ground for a flashover current.

### BRIEF DESCRIPTION OF THE DRAWINGS

FIG. 1 is a three dimensional view of an inductive coupler installed on a power line showing an intended location for flashover to discharge to electrical ground.

FIG. 2 is a sectional view of the inductive coupler of FIG. 1.

FIG. 2A is a schematic of a portion of the inductive coupler of FIG. 1.

FIG. 3 is a three dimensional view of an inductive coupler installed on a power line having an intended path for flashover to the coupler's grounded secondary winding.

### DESCRIPTION OF THE INVENTION

In a PLC system, power current is typically transmitted through a power line at a frequency in the range of 50-60 hertz (Hz). In a low voltage line, power current is transmitted with a voltage between about 90 to 600 volts, and in a medium voltage line, power current is transmitted with a voltage between about 2,400 volts to 35,000 volts. The frequency of the data signals is greater than or equal to about 1 megahertz (MHz), and the voltage of the data signal ranges from a fraction of a volt to a few tens of volts.

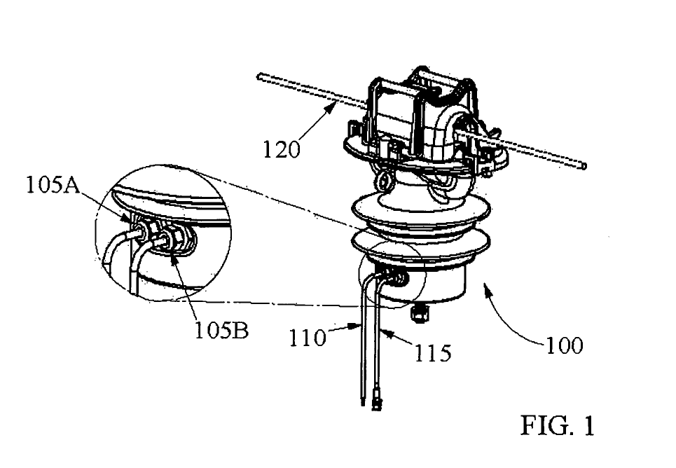

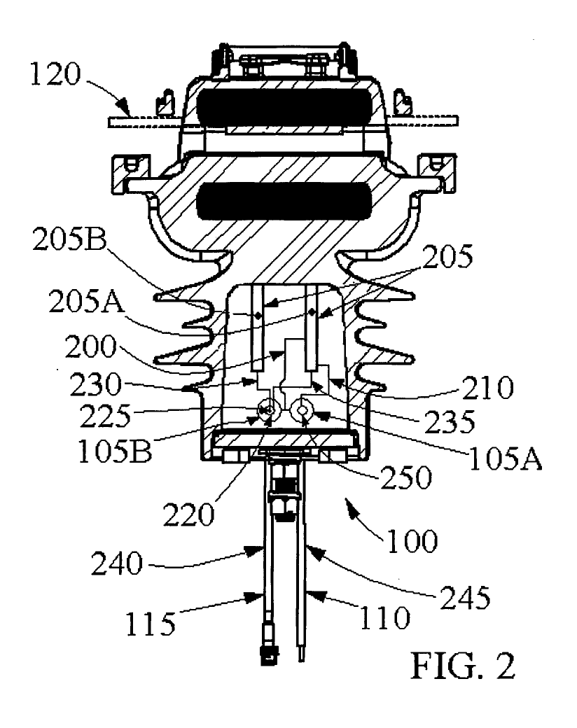

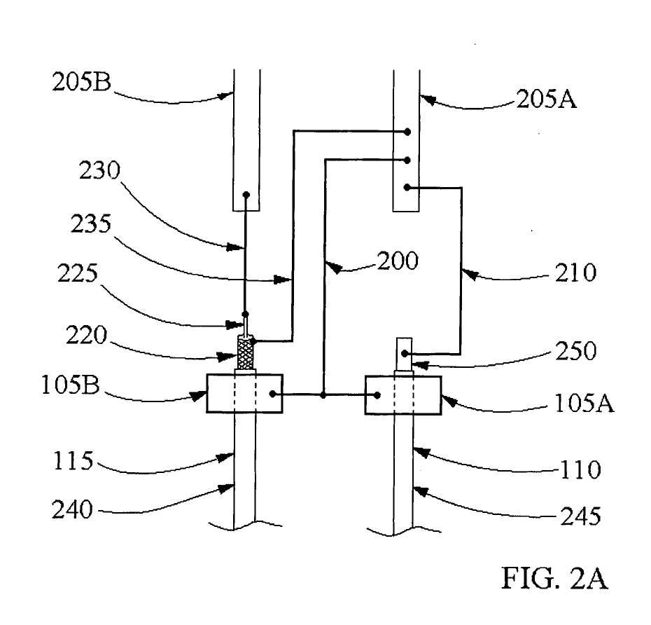

FIG. 1 is a three dimensional view of an inductive coupler 100 on a conductor, i.e., a power line 120. Inductive coupler 100 includes a magnetic core (not shown), and a winding (see FIG. 2, reference 205), wound around a portion of the magnetic core. The magnetic core is generally, cylindrical-shaped, having an aperture the length of the cylinder, and power line 120 is routed through the aperture. Inductive coupler 100 operates as a transformer, where power line 120 serves as a primary winding of the transformer, and winding 205 is a secondary winding of the transformer.

As a voltage on power line 120 increases in magnitude with respect to electrical ground, the voltage may reach a magnitude at which a flashover will occur between power line 120 and a surface that is at ground potential. If a plurality of surfaces exist at similar distances from power line 120, and if some of these surfaces are conductive and others of these surfaces are non-conductive, the flashover is more likely to occur between power line 120 and one of the conductive surfaces.

A ground cable 110 and a coaxial cable 115 protrude out of a side of inductive coupler 100. An exposed end of ground cable 110 is fastened to a ground rod (not shown). Coaxial cable 115 is for connection with a modem or other communications equipment (not shown).

A cable housing fitting 105A houses ground cable 110 as it exits inductive coupler 100. A cable housing fitting 105B houses coaxial cable 115 as it exits inductive coupler 100. Cable housing fittings 105A and 105B each provide a liquid-tight cable strain relief through the housing of inductive coupler 100, for ground cable 110 and coaxial cable 115, respectively. Both of cable housing fittings 105A and 105B are made of a conductive material. As explained below, cable housing fittings 105A and 105B are also in a preferential path to electrical ground for flashover current.

FIG. 2 is another illustration of inductive coupler 100, and shows a configuration of several internal components. Inductive coupler 100 includes a winding 205, as mentioned above. Winding 205 is a length of conductive material, e.g., a wire, having two ends, i.e., a winding side 205A and a winding side 205B.

FIG. 2A is a schematic showing electrical connections between several of the components of inductive coupler 100.

Coaxial cable 115 has a center conductor 225, a conductive outer sheath, i.e., sheath 220, and a coaxial cable jacket 240. Coaxial cable jacket 240 provides insulation between cable housing fitting 105B and sheath 220. An electrical connection 230 connects winding side 205B to center conductor 225, and an electrical connection 235 connects winding side 205A to sheath 220. Thus, a data signal can be coupled between winding sides 205A and 205B and a communication device (not shown) via coaxial cable 115.

A ground cable jacket 245 provides insulation between conductor 250 and cable housing fitting 105A, and as mentioned above, coaxial cable jacket 240 provides insulation between cable housing fitting 105B and sheath 220. However, an electrical connection 200 connects cable housing fittings 105A and 105B to winding side 205A, and an electrical connection 210 connects winding side 205A to an exposed conductor, i.e., a conductor 250, of ground cable 110. Thus, cable housing fittings 105A and 105B are electrically grounded. If a flashover were to discharge through ground cable jacket 245 or coaxial cable jacket 240, the insulation could be damaged by the flashover current. However, since cable housing fittings 105A and 105B are conductive and electrically grounded, cable housing fittings 105A and 105B would attract the flashover current, and provide a path to ground through electrical connection 200, winding side 205A, electrical connection 210 and ground cable 110.

As mentioned above, FIG. 2A is a schematic. As such, FIG. 2A is intended to represent electrical connections, and not necessarily a physical embodiment of the connections. For example, electrical connection 200 could be in a form of a metal plate, and be directly connected to ground cable 110 rather than to winding side 205A. In any case, each of cable housing fittings 105A and 105B, electrical connection 200, winding side 205A, electrical connection 210 and ground cable 110 are at electrical ground potential, and are of an adequate size to accommodate any current that they are expected to handle.

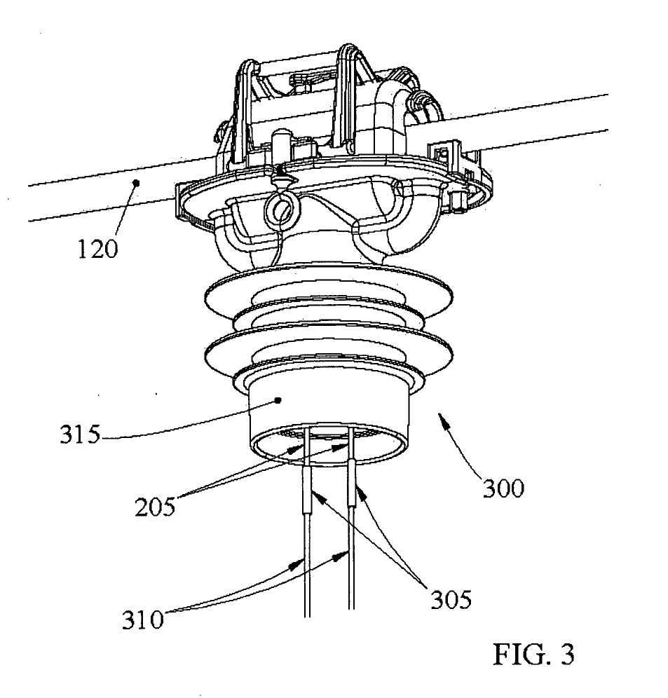

FIG. 3 shows an inductive coupler 300 where winding 205 is connected to cables 310 such that there are exposed surfaces 305 on a conductor connected to inductive coupler 300. Surfaces 305, as shown in FIG. 3, are surfaces of electrically conductive connectors situated at points where winding 205 is connected to cables 310. Provided that cables 310 lead to electrical equipment (not shown) that connects winding 205 to electrical ground, exposed electrically conductive surfaces of cable 310, and/or exposed surface 305, as well as winding 205's exposure below coupler insulation 315, can individually or collectively function as a potential path to electrical ground for flashover current.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. An inductive coupler for coupling a signal to a conductor, comprising
a magnetic core having an aperture through which said conductor is routed when said inductive coupler is installed on said conductor;
a winding wound around a portion of said magnetic core, wherein said signal is coupled between said winding and said conductor via said magnetic core; and
an electrically conductive member on an exterior of said inductive coupler that provides a path to electrical ground for a flashover current.

2. The inductive coupler of claim 1, further comprising a connection that connects said member to said electrical ground.

3. The inductive coupler of claim 1, wherein said member is at electrical ground potential.

4. The inductive coupler of claim 1, wherein said member is a fitting on a surface of said inductive coupler.

5. The inductive coupler of claim 1, wherein said member is an exposed surface on a conductor connected to said inductive coupler.

6. An inductive coupler for coupling a signal to a conductor, comprising
a magnetic core having an aperture through which said conductor is routed when said inductive coupler is installed on said conductor;
a winding wound around a portion of said magnetic core, wherein said signal is coupled between said winding and said conductor via said magnetic core; and
a member on a surface of said inductive coupler, wherein said member is electrically conductive, at electrical ground potential, and provides a path to electrical ground for a flashover current.

7. An inductive coupler for coupling a signal to a power line, comprising
a magnetic core having an aperture through which said power line is routed when said inductive coupler is installed on said power line;
a winding wound around a portion of said magnetic core, wherein said signal is coupled between said winding and said power line via said magnetic core; and
a conductor on an exterior of said inductive coupler, wherein said conductor has an exposed surface, is at electrical ground potential, and provides a path to electrical ground for a flashover current.

8. The inductive coupler of claim 1, wherein said flashover current is due to a flashover from said conductor.

9. A method comprising:
situating an inductive coupler on a power line, wherein said inductive coupler has an electrically conductive member on an exterior surface thereof; and
connecting said electrically conductive member to an electrical ground.

10. The method of claim 9, wherein said connecting provides a path, via said electrically conductive member to said electrical ground, for a flashover current.

11. The method of claim 10, wherein said flashover current is due to a flashover from said power line.

12. The method of claim 11, wherein said inductive coupler comprises:
a magnetic core having an aperture through which said power line is routed when said inductive coupler is installed on said power line; and
a winding wound around a portion of said magnetic core.

13. The method of claim 12, wherein said magnetic core couples a data signal between said winding and said power line.

14. The method of claim 13, wherein said data signal has a frequency of greater than or equal to about 1 megahertz.
